(19) United States
(12) Patent Application Publication
(10) Pub. No.: US 2007/0143422 A1
(43) Pub. Date: Jun. 21, 2007

(54) Phonebook use to filter unwanted telecommunications calls and messages

(76) Inventor: Yigang Cai, Naperville, IL (US)

Correspondence Address: Werner Ulrich, 434 Maple St., Glen Ellyn, IL, 60137, US

(21) Appl. No.: 11/314,108

(22) Filed: Dec. 21, 2005

(51) Int. Cl. G06F 15/16

(52) U.S. Cl. 709/206

(57) ABSTRACT

This invention relates to the use of a customer phonebook feature for storing white lists and black lists for filtering unwanted voice calls or data messages. It also relates to the automatic population of a customer phonebook of identifications of a destination of outgoing calls. Advantageously, the phonebook can be rapidly and effortlessly populated with white lists and black lists to reduce processing for determining whether incoming calls or messages should be blocked or passed to the called destination.

### TECHNICAL FIELD

This invention relates to the filtering of unwanted communications and, more specifically, to the use of a phonebook facility to assist such filtering.

### BACKGROUND OF THE INVENTION

With the advent of the Internet, it has become easy to send messages to a large number of destinations at little or no cost to the sender. The same is true of short message service (SMS). These messages include unsolicited and unwanted messages (spam) which are a nuisance to the receiver of the message who has to clear the message and determine whether it is of any importance. Further, it is a nuisance to the carrier of the telecommunications network used for transmitting the message, not only because it presents a customer relations problem with respect to irate customers who are flooded with spam, but also because these messages, for which there is usually little or no revenue, use network resources. An illustration of the seriousness of this problem is given by the following two statistics. In China in 2003, two trillion short message service (SMS) messages were sent over the Chinese telecommunications network; of these messages, an estimated three quarters were spam messages. The second statistic is that in the United States an estimated 85-90% of e-mail messages are spam.

A problem of the prior art is to minimize additional processing of messages (e-mail or SMS/MMS messages) while still filtering the bulk of the messages in order to minimize the number of spam messages which are sent to the recipient.

A further problem is the filtering of unwanted voice calls or unwanted messages from known sources. The arrangements for performing such filtering, such as the filtering of nuisance calls are difficult to control and generally limited.

### SUMMARY OF THE INVENTION

Applicant has carefully studied these problems and has concluded that the phonebook facility available in such applications as the Active Phonebook system available from Lucent Technologies Inc. can be usefully employed to perform white list (WL) (accept) and black list (BL) (reject) screening of all types of incoming and outgoing communications, including SMS messages, voice calls, video calls, e-mail messages, and instant messages. Applicant has inventively discovered a method and apparatus for helping to overcome the problem of the prior art and is adding to the prior art in accordance with this invention wherein incoming and outgoing communications, including voice or video calls and data messages, are checked against a white list and a black list stored in a network based phonebook associated with the destination device and for passing communications to that destination device if the source or destination is in the white list, or blocking communications if the source or destination is in the black list. The network based phonebook is automatically updated from the phonebook in the customer's device (customer premises equipment) in response to customer requests; changes in the current status of terminals, detected in the network are used to update the network based phonebook, and thence, the phonebook in the customer's device. Advantageously, this minimizes or eliminates further processing of an incoming communication to determine whether it should be passed if the source of the communication is in the white list, or blocked if the source is in the black list. That will significantly increase network efficiency, save network resources, and make the telecommunication service more attractive. It will also allow for a more rapid and more user friendly customer change facility.

In accordance with one feature of Applicant's invention, when the customer device is used for originating an outgoing call, the outgoing number or other identification, appropriately filtered, is automatically entered into the white list or black list stored in the phonebook associated with the device if the customer dials an appropriate indication code; this process is based on the assumption that appropriately filtered destination identifications are not likely to be sources of unwanted messages or calls, or that a customer has recognized a good black list entry. The filtration can lead, for example, to the storage of numbers or identifications only in pre-specified area codes or can include or exclude foreign destinations numbers. Advantageously, a useful white list and/or black list can be built up and augmented automatically. The network will query the public number database to obtain the names associated with the outgoing numbers; the names/numbers are then saved together in the device phonebooks. The network will also convert E-mail addresses, instant message user identifications and others into a wireless or wireline number if the outgoing identity is not a phone number.

In accordance with another feature of Applicant's invention, the outgoing number is automatically added to the non-filtration database (i.e., the database excluding the black list and white list) of the phonebook. Advantageously, this allows the non-filtration database of the phonebook to be populated automatically. The automatic addition to the white list or black list can be requested or inhibited if the caller dials a special prefix or suffix code such as * * #. The prefix or suffix can indicate whether the number is to be added to the phonebook white list or black list. Advantageously, the automatic addition to the phonebook allows a caller to utilize phonebook features immediately on any call to a new destination, and allows for immediate customized updating of the customer's white list and black list.

The network based phonebook will automatically synchronize all contact lists for the end user. For example, contact lists on all clients/devices such as mobile phone, Personal Digital Assistant (PDA), personal computers (PC), smart phone will be updated. The contact lists can be phonebook, address book, buddy list for applications of IM, SMS/MMS, Push to Talk, E-mail, Interactive Game.

### BRIEF DESCRIPTION OF THE DRAWINGS(S)

FIG. 1 is a block diagram illustrating the operation of Applicant's invention;

FIG. 2 is a flow diagram illustrating the operation of Applicant's invention for incoming calls or messages;

FIG. 3 is a flow diagram illustrating the operation of Applicant's invention for outgoing calls or messages; and

FIG. 4 is a flow diagram illustrating the process of adding a number to the white list of a customer's phonebook.

### DETAILED DESCRIPTION

The basic objective of Applicant's invention is to allow the black list and white list of Applicant's phonebook to be used to reject unwanted voice calls or data messages, to accept known wanted voice calls and data messages, and to deal with the different types of services available in the telecommunications network. While, at this time, the phonebook is only connectable to a wireless station, the basic equipment is such that it can also be connected to a land-based telephone station. Further, a number of facilities already exist independent of the phonebook for storing and processing information on black lists (reject) and white lists (accept). The integration of phonebook facilities gives the telecommunications customer more immediate control of the sources and destinations to be subject to black and white list control. The basic phonebook is associated with a wireless station or a land-based station. In order to make the phonebook accessible to the various elements of the telecommunications network, an active phonebook accessible via the public switched Internet Protocol network and the signaling portion of the public switched Signaling System 7 (SS7) network. This active phonebook contains a white list and a black list that can be accessed before completing an incoming or outgoing voice, video, or data call.

The customer's phonebook can be used by the customer to check and update family/friend address, availability and current locations of voice phone, video, email, IM, SMS. The client software within the customer's device interfaces with the Active Phonebook Server to obtain the above information dynamically. This invention adds a permit(block list to the capabilities of the phonebook allowing the customer's phonebook to sync up with an Active Phonebook server to input allow/disallowed entries to the network based Active Phonebook server.

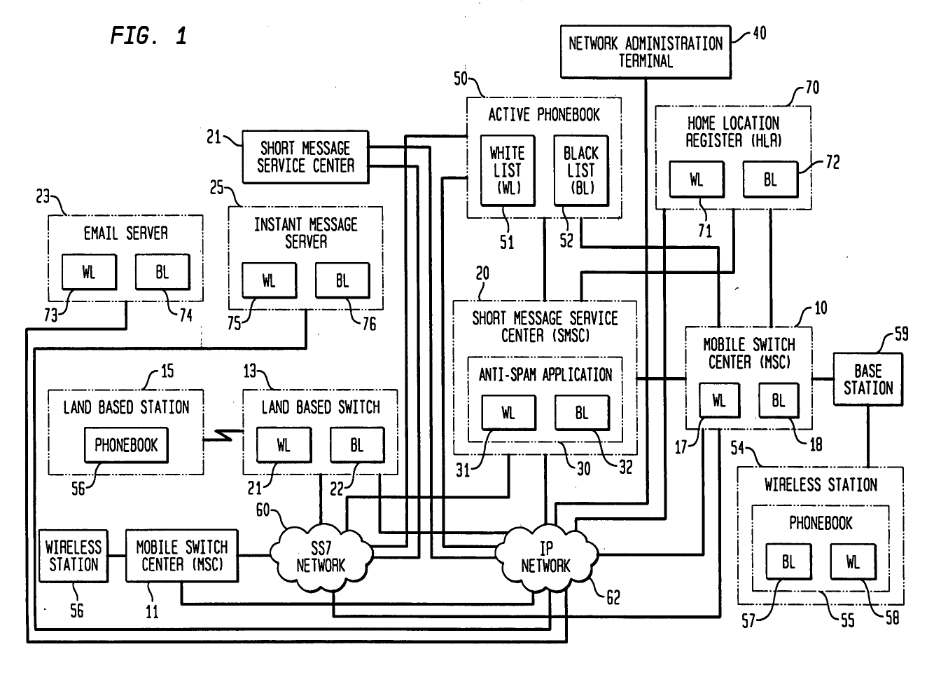

FIG. 1 illustrates the interconnection among the various network elements and the active phonebook 50. The term “network elements” as used herein comprises mobile switching centers 10, 11 for serving cellular calls; land-based switches 13 for serving calls to or from a land-based telephone station 15; short message service centers 20, 21 for serving short message service (SMS) data messages; e-mail servers 23 for serving e-mail and instant message servers 25 for serving instant messages. Of these elements, the short message service center is unique in having an anti-spam application 30 either directly apart of the short message service center (as shown) or closely associated with the short message service center. The spam problem, discussed in the Background of the Invention, is a particularly acute problem for short message service which is why in the present and future public switched telecommunications network the short message service center is equipped to filter out as much spam as possible. The anti-spam application has its own black list 32 and white list 31 controlled from a network administration terminal 40 and built up over time. In addition, the anti-spam application 30 or the short message service center 20 checks the active phonebook 50 to see if the source is on a white list or black list for the destination station. In accordance with Applicant's preferred embodiment, the active phonebook is checked first or in parallel and a white list or a black list entry in the active phonebook dominates the processing of the call.

The primary black list 52 and white list 51 that is the subject of this invention is that of a network based active phonebook 50, accessed by the various network elements prior to establishing a voice or video or data connection. Separate black lists and white lists are provided for incoming and outgoing service. The black list for outgoing service can include, for example, restrictions to limit voice calls to foreign countries. The black list for incoming calls can include lists of advertisers whose calls or messages are not wanted by the customer. The customer only controls the customer device phonebook 55, including black list 57 and white list 58, directly. The phonebook within the wireless station equipment or the land-based station equipment updates the active phonebook, including black list 52 and white list 51 through messages sent via the IP network 62 or the signaling portion of the SS7 network 60. The other black lists and white lists shown in FIG. 1 are controlled from the network administration via a network administration terminal. The terminal is connected to the various network elements by the public switched SS7 network 60 signaling facilities and by the public Internet Protocol network 62 which serves both Internet Protocol (IP) messages and Internet Protocol multimedia (IM) messages.

The home location register 70 serves as a database for the mobile switching center. It also contains a white list 71 and black list 72 which can be used further for controlling completion of voice or data calls to or from cellular stations.

Calls originated from the wireless station 54 pass through a radio base station 59 to a mobile switching center 10. Thence, they are sent via the SS7 network 60 to a mobile switch center 11 or a land-based switch 13. Outgoing calls are checked to see if the destination is in an outgoing portion of black list 18, incoming calls are checked to see if they are in an incoming portion of black list 18. Before a call received in a mobile switching center is sent on to a station identified as the destination of the call, the mobile switching center will check whether the destination station is willing to accept calls from the source, i.e., whether the source is on a white list or is not on a black list associated with the destination station. In addition, the-mobile switching center checks the active phonebook 50 to see if the source is on a white list or black list for the destination station. In accordance with Applicant's preferred embodiment, the active phonebook is checked first or in parallel and a white list or a black list entry in the active phonebook dominates the processing of the call.

For calls originating or terminating on a land-based station 15, the call is served by a land-based switch 13. The call is received from or sent to a public switched SS7 network. The land-based switch checks its own black list 22 and white list 21 but also the black list 52 and white list 51 of the active phonebook 50 to see if calls from a source of an incoming call or a destination of an outgoing call are in the white list or black list of the active phonebook.

Calls served by an e-mail server 23 or an instant message server 25 are routed through the public IP network 62. These calls are also checked against a white list 73 or 75, and a black list 74 or 76 of the corresponding server (e-mail or IM, respectively). The server also checks the active phonebook white list and black list. The e-mail server and IM server access the active phonebook through the IP network.

White list and black list entries are made for each type of telecommunications device of a customer. This permits a customer to place a communications source on a black list of, for example, a cellular station and on a white list, for example, of a land-based station; similarly short message service messages may be accepted but not instant messages and not e-mail. Further, and this is especially useful for voice calls, time of day and day of week restrictions may be provided so that a white list entry is active only during business hours or only outside business hours.

As mentioned above, the short message service center is a special case because this center must directly or indirectly filter out spam as well as messages from pre-identified sources. For example, the anti-spam facility 30 can be provided to filter out pornographic messages based on the content of the message without having to rely on a previously known pornographic source list. The anti-spam facility 30 contains a white list 31 and black list 32. However, the short 5 message service center also takes advantage of the immediate and complete control provided by the phonebook arrangement to reject or allow messages from a source specified by the customer who owns the phonebook. Because of the high traffic between the short message service center 20 and the active phonebook 50, it may be desirable, as illustrated, to provide a direct link between these two units as well as providing the link via the SS7 and IP networks.

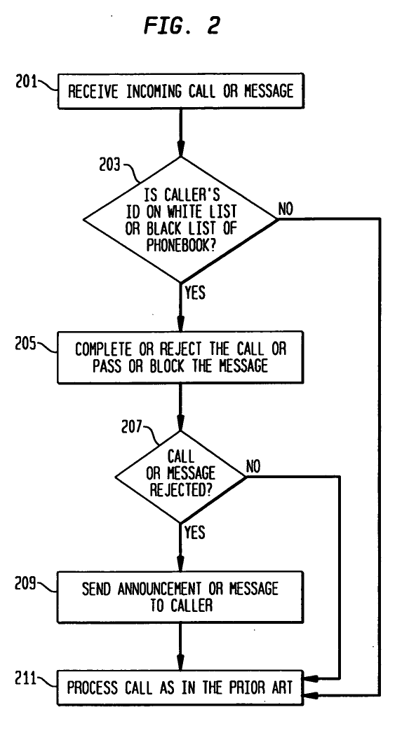

FIG. 2 is a flow chart illustrating the operation of Applicant's invention. One of the network elements listed above receives an incoming call or message (action block 201). Test 203 is used to determine if the caller's identification is on the white list or black of the active phonebook. If the caller's identification is on a white list or black list of the phonebook, then the call is completed or the message is passed (white list) or the call is rejected or the message blocked (black list) (action block 205). Test 207 determines whether the call or message has been rejected. If the call or message has not been rejected, then the call is processed as in the prior art (action block 211). If the call or message has been rejected, then an announcement or message is sent to the caller (action block 209). If the result of test 203 is that the caller's identification is not on a white list or black list of the phonebook, then the call is processed as in the prior art (action block 211).

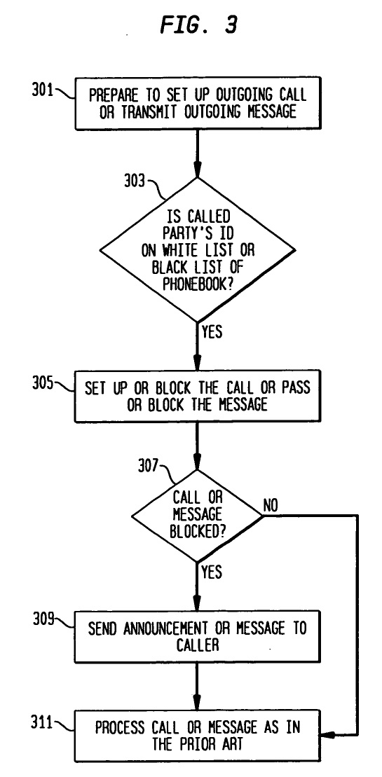

FIG. 3 illustrates the processing of outgoing calls or messages. The system prepares to set up an outgoing call or transmit an outgoing message (action block 301). Test 303 is used to determine whether the called party's identification is on a white list or a black list of the phonebook. If the result of test 303 indicates that the called party's ID is on a white list or black list of the phonebook, then the call is set up or blocked or the message is passed or blocked in accordance with whether the identity was on a white list or black list (action block 305). In case the call or message is blocked (test 307), then an announcement or message is sent to the caller (action block 309). If the result of test 303 is that the called party's identification is not on a white list or a black list of the phonebook, then the call or message is processed as in the prior art (action block 311).

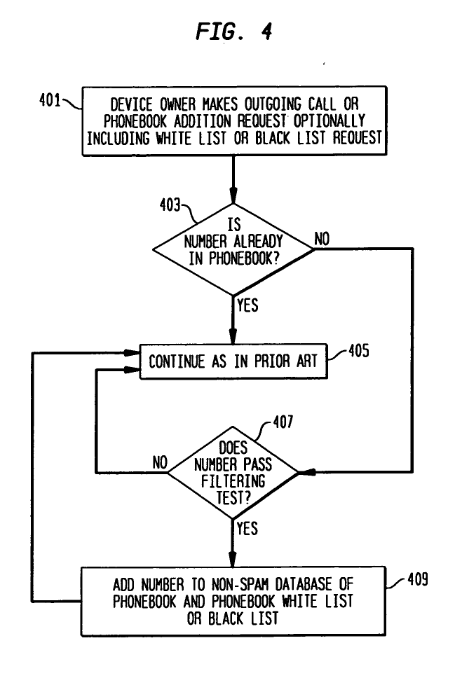

FIG. 4 is a flow diagram illustrating a process for adding an entry into the phonebook of a device owner. The device owner makes an outgoing call (action block 401). Test 403 is used to determine whether the number or identification of the outgoing call is already in the phonebook. If it is, then the outgoing call is processed as in the prior art (action block 405). If the number is not already in the phonebook, then test 407 is used to determine-whether the number passes a filtering test for entering numbers and other identification into the non-spam portion and/or in the white list or black list of the caller's phonebook. The filtering may, for example, eliminate from the white or black list of the caller's phonebook numbers that are not in a pre-specified list of area codes or numbers located in foreign locations. If the called number passes-the filtering test (positive result of test 407) then the number is added to the white or black list in the phonebook and in the main entry of the phonebook (action block 409). The main entry, white list or black list entry is not made if the caller dials an appropriate prefix or suffix such as * * #. If the number does not pass the filtering test, then the call is processed as in the prior art. Also, following action block 409 the call is processed as in the prior art (action block 405).

While in the preferred embodiment illustrated herein, the IP network 9 is used for more queries of the Active Phone Book 50, other arrangements such as direct data links, or the highly reliable signaling portion of the SS7 network can be used.

The above description is of one preferred embodiment of Applicant's invention. Other embodiments will be apparent to those of ordinary skill in the art. The invention is limited only by the attached claims.

I claim:

1. In a telecommunications system a method of rejecting unwanted communications, comprising the steps of:
responsive to receiving a communication, determining whether an identification of a source of said communication is in a white list of a phonebook of a called customer; and
if said identification of said source is in said white list, completing said communication.

2. The method of claim 1 further comprising the step of:
determining whether said identification of said source is in a black list of said phonebook; and
if said identification of said source is in said black list, rejecting said communication.

3. The method of claim 1 further comprising the steps of:
responsive to an origination of another communication by said called customer, determining whether a destination identification of said another communication is already in said white list; and
if said destination identification of said another communication is not in said white list, adding said destination number to said white list.

4. The method of claim 2 further comprising the steps of:
responsive to an origination of another call by said called customer, determining whether a destination identification of said another call is already in said black list; and
if said destination identification of said another call is not in said black list, adding said destination number to said black list.

5. The method of claim 1 wherein said communication is a short message service (SMS) message.

6. The method of claim 1 wherein said communication is an e-mail message.

7. The method of claim 1 wherein said communication is an instant message.

8. The method of claim 1 wherein said communication is a voice call.

9. The method of claim 1 further comprising the step of:
if said identification of said source is not in said white list, passing said message to an anti-spam application for further analysis.

10. The method of claim 2 further comprising the step of:
if said identification of said source is not in said black list, passing said message to an anti-spam application for further analysis.

11. The method of claim 1 further comprising the steps of:
responsive to an origination of another communication by said called customer, determining whether a destination identification of said another communication is in a phonebook of said called customer; and
if said destination identification of said another communication is not in said phonebook of said called customer, adding said destination identification to said phonebook.

12. The method of claim 11 wherein other destination identifications of a customer identified by said destination identification of said another communication are also added to said phonebook.

13. The method of claim 3 wherein other destination identifications of a customer identified by said destination identification of said another communication are also added to said white list.

14. The method of claim 4 wherein other destination identifications of a customer identified by said destination identification of said another communication are also added to said black list.

15. The method of claim 3 further comprising the step of:
adding a time and day restriction to the entry on said white list.

16. The method of claim 1 further comprising the step of:
testing whether a white list entry for said source includes a time and day restriction;
if a time and day restriction exists, preventing a completion of said communication if a present time falls outside said time and day restriction.

17. Apparatus for rejecting an unwanted communications, comprising:
customer station means comprising a customer phonebook, said phonebook controllable by a customer controlling said customer station means;
said customer phonebook comprising a black list of telecommunications sources from which communications are to be blocked;
means for accessing said customer phonebook for obtaining said black list;
network server means, responsive to said means for accessing, for storing said black list of said customer phonebook;
means responsive to receipt of a communication for determining whether a source of said communication is on said black list of said customer phonebook stored in said network server means; and
means for blocking completion of said communication if said means for determining determines that said source is on said black list in said server means.

18. Apparatus for accepting wanted communications, comprising:
customer station means comprising a customer phonebook, said phonebook controllable by a customer controlling said customer station means;
said customer phonebook comprising a white list of telecommunications sources from which communications are to be accepted;
means for accessing said customer phonebook for obtaining said white list;
network server means, responsive to said means for accessing, for storing said white list of said customer phonebook;
means responsive to receipt of a communication for determining whether a source of said communication is on said white list of said customer phonebook stored in said network server means; and
means for allowing completion of said communication if said means for determining determines that said source is on said white list in said server means.
